(19) United States
(12) Patent Application Publication
(10) Pub. No.: US 2008/0273665 A1
(43) Pub. Date: Nov. 6, 2008

(54) Adjustable Radiographic Marker and Calibration Aid

(76) Inventors: Michael Rolle, Castro Valley, CA (US); Roger Boots, Castro Valley, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 11/744,395

(22) Filed: May 4, 2007

(51) Int. Cl. G01B 15/00

(52) U.S. Cl. 378/165

(57) ABSTRACT

A device and method to accurately measure the anatomy of a patient undergoing a radiographic procedure, utilizing a sphere of known dimensions attached to a flexible member, wherein the sphere is manipulated into the correct position and remains stationary during the procedure.

### FIELD OF THE INVENTION

The invention relates to radiographic imaging. More specifically, it relates to a device and method for measuring radiographic images more accurately than has been the case in the past.

### BACKGROUND OF THE INVENTION

There are currently a variety of ways to make physical measurements of a patient's body or anatomical part in an x-ray image (radiograph) with varying degrees of accuracy. One method is to use a radio opaque marker that is either constructed to be a specific size, or that contains a ruler, placed on either the patients body or on the x-ray table, cassette, or digital receptor directly adjacent to the patients body in a place where it will be visible in the final x-ray or other image. Once the resultant image is available, a physician or technician can measure the marker on the film or, in the case of a digital image, use a software program to measure the marker. Since the marker is most likely not at the exact film or receptor plane, or at the anatomical region of interest, and given that any space between a marker and a film or receptor plane will result in some magnification factor (the device in the image appears larger than it actually is), the physician or technician must mathematically calculate this factor in multiple steps. This procedure can include calculating the magnification factor at the plane of the marker, making a correction for the increase in magnification factor as the distance between the anatomical area or region of interest and the film plane/receptor plane is increased, then establishing the magnification factor at the anatomical region of interest to finally arrive at a semi-accurate measurement.

Another method is to affix, in some manner, a known size sphere to the patient's body or clothing in an area that is as close as possible to the region of interest, for example, a hip bone. In this case the resultant image would show the patient's anatomy and the known size sphere in the same plane. The magnification factor can then be calculated and applied to the measurement of the anatomical region of interest. The inherent problem with this device is that variations in skin tone and elasticity can cause the attached marker to sag and makes it difficult for a technologist to position accurately. The same would hold true for an attachment to fabric or clothing. Another problem is that of patient movement. Any movement at all could alter the location of the marker and cause an incorrect measurement to be made.

Another method is available where evenly spaced marks at a given distance on the outer edge of an image from a digital source (Computed radiograph or Digital/Direct radiograph) can be used to attain a magnification factor directly at the receptor plane. Calculations still must be made to correct for the increasing magnification factor as the distance between the anatomical part or region of interest increases. For instance Marks (U.S. Pat. No. 5,149,965) discloses a radio opaque sphere of known dimensions with means for positioning in a radiographic image field and a method for scaling radiographic images including straight AP and lateral views using such a radio opaque sphere. The invention described in Marks is distinguishable from the invention described herein in a variety of ways, including that the sphere in Marks can only be manipulated in two dimensions, while the invention described herein can be manipulated in three dimensions.

### Discussion of Prior Art

During radiology procedures, it is often necessary to determine the size of structures within the body. Because there is an unknown magnification factor relating the actual size of structures to be measured with the images formed on film, it is desirable to have an object of known dimensions with which to compare the body structure. The products that currently exist place a known sized marker at some point between the x-ray source and reception device. The reception device can include a digital receptor, a computed radiography plate and cassette, or a standard film and cassette. Most such devices place the known size marker at a plane in the x-ray field that is different than that of the anatomical region being studied. Wiedenhoefer (U.S. Pat. No. 6,459,772) differs from this in that it allows a sphere of a known size in the same plane as the anatomical target of the x-ray. Wiedenhoefer is distinguishable from the invention described herein in many other important ways, including that the Wiedenhoefer device is encased in a plastic radio opaque fixture, and attached to the patient's body or clothing by way of a disposable adhesive tape mount. The invention described herein does not require encasement of the sphere. It can be easily positioned into many planes in three dimensions, and is completely reusable.

Problems associated with a known size marking device being at a plane other than that of the patient's body or anatomical region of interest is that it requires calculation to arrive at a true measurement of the anatomy being studied. These calculations take time and expense to complete, and are prone to errors.

The problems with a known size marking device being attached to a patient's skin or clothing is that simple movement combined with loose skin or clothing can alter the location of the device after positioning and cause inaccurate measurements to be used to calculate the true size of anatomical part or region of interest.

Therefore, a general need exists to provide the radiologists and others with a method for the accurate determination of the degree of magnification of radiographic images. A more specific need exists for a method and apparatus capable of facilitating the accurate calculation of the degree of magnification of radiographic images which is both less sensitive to the orientation of the marker relative to the beam of radiation, and easily positioned into the appropriate anatomical location.

### SUMMARY OF THE INVENTION

It is an object of the present invention to provide a method and apparatus or device for facilitating the accurate calculation of the degree of magnification of radiographic images (including digital and analog radiographic images). The description below is generally in the context of developed analog radiographic images made on X-ray film with a conventional X-ray machine, but it will be understood that the images would be essentially the same if the images were made digitally using a digital radiation detector also known as a digital X-ray machine.

Accordingly, the present invention advantageously relates to a radiographic reference marker which satisfies each of the aforementioned criteria. In a preferred embodiment, the reference marker comprises a base portion, preferably plastic, that has a flexible plastic arm attached to it. A radio opaque sphere, preferably made of stainless steel, is mounted at the outer end of the flexible arm. This allows the device to be placed on the x-ray table adjacent to the patient and the arm and ball or sphere to be positioned adjacent to the anatomical part being studied.

An alternative embodiment of the invention comprises a magnetic metal base that has a flexible plastic arm attached to it. A radio opaque sphere, again preferably stainless steel, is mounted at the other end of the flexible arm. This allows the device to be magnetically attached to an x-ray table or an upright x-ray stand, while allowing the arm and sphere to be positioned adjacent to the anatomical part being studied.

Another embodiment of the invention comprises a flexible plastic arm with an attached sphere on one end of the flexible arm. The other end of the arm comprises a means to attach the arm to a fixed position. This allows the device to be mounted to an x-ray table or an upright x-ray Bucky, and the arm and sphere to be positioned adjacent to the anatomical part being studied. A Bucky is a device that moves the grid while the x ray is being taken. A grid is a device containing lead strips that is placed between the patient and the x-ray film to absorb scattered x-ray photons before they reach the x-ray film. The motion keeps the lead strips from being seen on the x-ray picture.

The invention described herein solves the problems existing in the prior art, by allowing the measurement apparatus or device to be located on the plane of the anatomical part being studied, and by it being adjustable, flexible, and easy to operate with one hand.

The invention solves the problems associated with devices that are attached to moveable surfaces by not being attached to anything other than its own plastic or magnetic base. Further, it is fully reusable without the need for disposable supplies.

### BRIEF DESCRIPTION OF THE DRAWINGS

FIG. 1 is a perspective view of an embodiment of the invention.

FIG. 2 is perspective view of the bottom of the base of the embodiment of the invention shown in FIG. 1.

FIG. 3 is a perspective view of an embodiment of the invention showing how the flexible arm is attached to the base.

FIG. 4 is a side view of a portion of the flexible arm component of an embodiment of the invention.

FIG. 5 is a perspective view showing the placement of the apparatus of the invention adjacent to an anatomical part being x-rayed.

FIG. 6 is a perspective view of an embodiment of the invention.

### DETAILED DESCRIPTION OF THE INVENTION

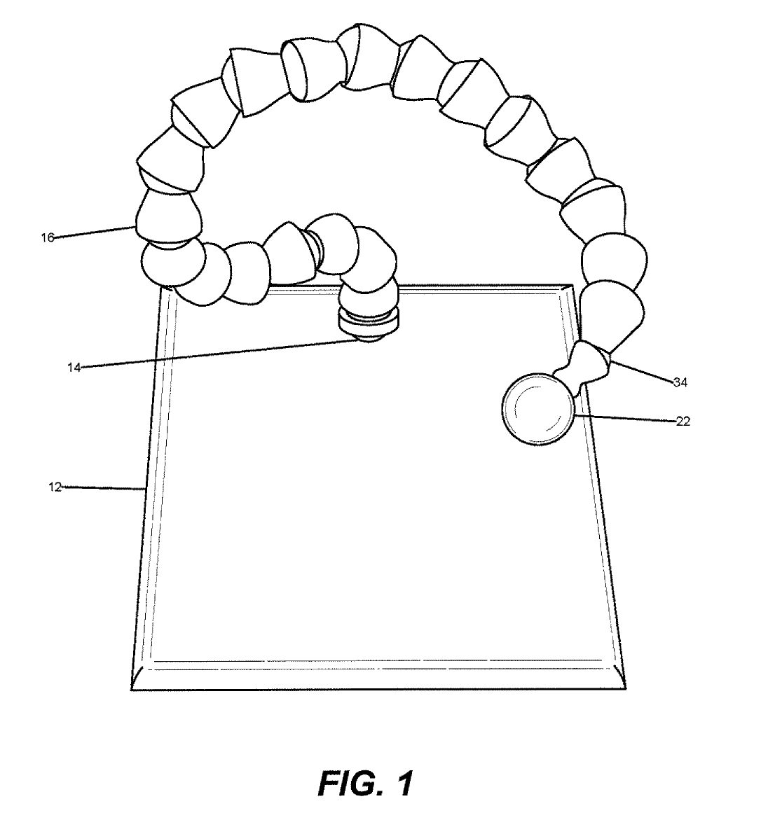

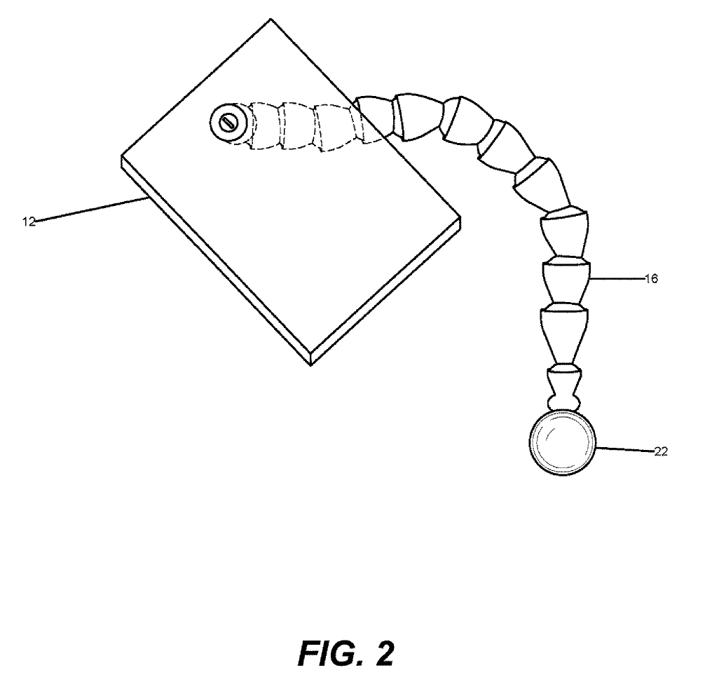

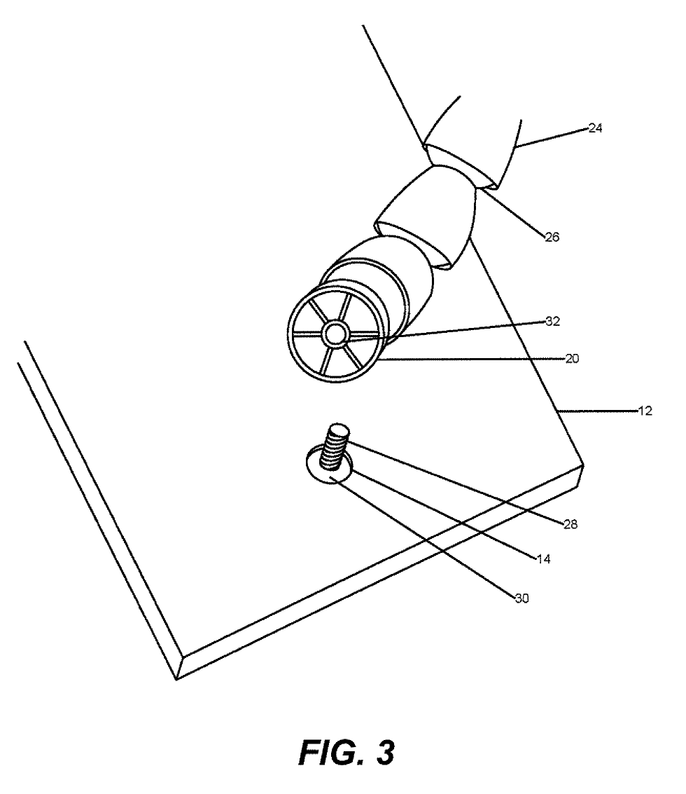

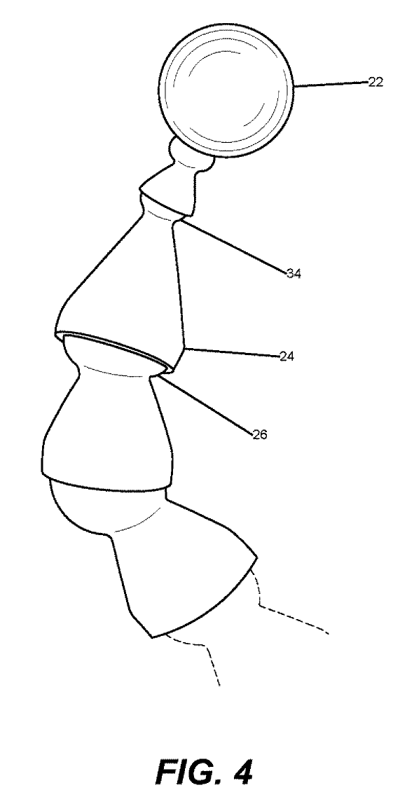

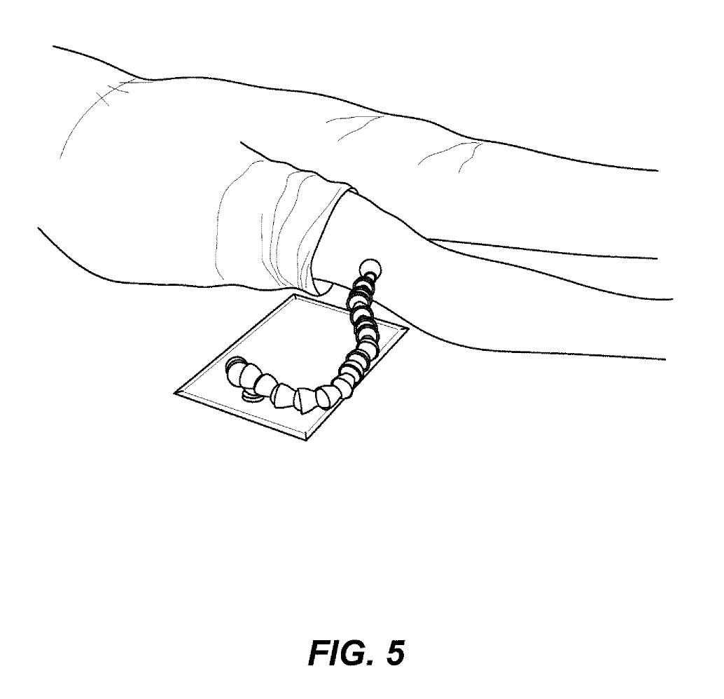

The device or apparatus of the invention is seen in FIG. 1-6. The apparatus comprises a base 12 having an orifice or hole 14 in the center of a side of the base 12.

A flexible arm 16 is attached to the base. The flexible arm comprises a series of links. A base link 20 is positioned at one end of the flexible arm 16, for attachment to the base 12, while a radio opaque sphere 22 is attached at the far end.

Each link comprises a core sphere tubular neck portion 24 and a ball 26. The ball 26 of one link fits into the hollow neck 24 of the adjacent link, forming a ball and socket configuration. The ball 26 of one link is in a tight relationship of the neck 24 of the adjacent link, such that three dimensional flexibility is obtained, nevertheless rigidity is maintained.

The arm 16 is attached to the base 12 by means of a screw 28 inserted through a washer 30, through the hole 14 in the base 12, and screwed into threads 32 in the base link 20. The flexible arm 16 can be made of metal, plastic or of inter-locking plastic segments (known brand name LOC-LINE™ from Lockwood Products, Inc.) and similar plastic segments, which are available from different manufacturers and give the same effect. The arm 16 made of these link segments can be manipulated in any direction, axis or shape. The second to last link in the flexible arm 16 is an adapter link 34 which reduces the tubing size from ½″ to ¼″ and the final link is ¼″. These sizes are preferable, but not required. The sphere 22 is attached to the end of the flexible arm 16. The sphere 22 can comprise a variety of sizes depending on the specific medical procedure being used. FIG. 1 shows a 25.4 mm sphere with a 6/32″ threaded hole approximately ⅝″ deep mounted at the end of the flexible arm with a 8/32×1″ nylon screw fixed into place with epoxy to minimize loosening over time. The specific measurements disclosed herein are not required elements of the device, nor limitations of the invention.

This is a device that gives the ability to quickly, easily, reproducibly & accurately determine the magnification factor at the plane of anatomy in a radiographic image.

The flexible arm 16 is used to position the sphere 22 in a location that is just adjacent to, and at the same plane, as the anatomical region being studied in a radiographic image. In most situations, the size of the sphere 22 will be a 25.4 mm (1 inch), however other sizes could also be used. The result will allow for a determination, in a reproducibly accurate fashion, of the magnification factor or true size of the anatomy in the radiographic image.

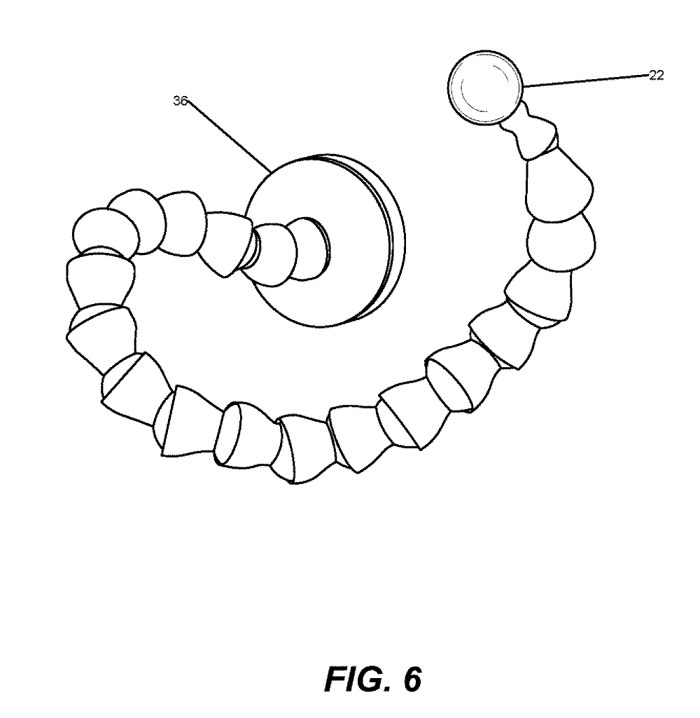

FIG. 6 shows an embodiment of the invention wherein the base member comprises a magnet 36. The magnet 36 is attached to an end of the flexible member, and is capable of attachment to a metallic or other magnetic surface. This embodiment can be used in a variety of instances, such as when the magnetic base can be placed against a nearby object to support and stabilize the apparatus during use. Although not shown in a drawing, the apparatus could also be permanently affixed to the imaging device or on a related piece of equipment that is typically located near the imaging device.

I claim:

1. A radiographic reference marker comprising:
a. an elongated flexible member having a first end and a second end;
b. a radio opaque sphere of a known diameter attached to the first end of the flexible member.

2. The radiographic reference marker of claim 1, wherein the second end of the elongated flexible further comprises a means of attachment to a fixed object.

3. The radiographic reference marker of claim 1, further comprising a base member attached to the second end of the flexible member.

4. The radiographic reference marker of claim 2, wherein the means of attachment to a fixed object comprises a clip.

5. The radiographic reference marker of claim 2, wherein the means of attachment to a fixed object comprises a magnet.

6. The radiographic reference marker of claim 2, wherein the means of attachment to a fixed object comprises a suction cup.

7. The radiographic reference marker of claim 1, further comprising a means to magnetically attach the second end of the flexible member to a fixed object.

8. The radiographic reference marker of claim 1, wherein the means to magnetically attach the second end of the flexible member to another object comprises a magnetized metal.

9. A radiographic reference marker comprising:
a. a base;
b. an elongated flexible member capable of movement in three dimensions attached to the base, said flexible member having a first end and second end, the first end of said flexible member being attached to said base; and
c. a radio opaque sphere attached to the second end of said flexible member.

10. The reference marker of claim 9 wherein said flexible member comprises a series of interlocking segments.

11. The reference marker of claim 10 wherein each segment comprises a hollow neck portion having a ball attached to the end of it.

12. A method for determining the dimensions of a human anatomical structure within a three dimensional radiographic image field comprising:
a. manipulating the location of a sphere of known dimensions, wherein the sphere is attached to an elongated flexible member;
b. creating a radiograph of the spherical object and the human anatomical structure utilizing a radiographic device;
c. calculating the dimensions of the human anatomical structure by comparing the size of the image of the human anatomical structure to the known dimension of the spherical object in the radiograph.
